(19) United States
(12) Patent Application Publication
(10) Pub. No.: US 2016/0036299 A1
(43) Pub. Date: Feb. 4, 2016

(54) DRIVE DEVICE ASSEMBLED BY AN INTERFERENCE FIT

(71) Applicant: DENSO CORPORATION, Kariya-city (JP)

(72) Inventor: Jirou Hayashi, Ama-city (JP)

(21) Appl. No.: 14/812,767

(22) Filed: Jul. 29, 2015

(30) Foreign Application Priority Data
Jul. 31, 2014 (JP) 2014-156478

(51) Int. Cl. H02K 9/22; H02K 7/00; B62D 5/04; H02K 7/14; H02K 5/15; H02K 11/00; H02K 1/16; H02K 7/08

(52) U.S. Cl. CPC H02K 9/22; H02K 1/16; H02K 7/003; H02K 7/083; H02K 7/14; H02K 5/15; H02K 11/0073; B62D 5/0421

(57) ABSTRACT

A drive device is assembled with a fitting outer wall of a heat sink and a fitting inner wall of a frame combined by an interference fit. The drive device allows for a sufficient assembly accuracy of coaxiality, and may prevent a pulsation of motor torque and a vibration sound caused by a tilt of a shaft. Further, heat conductivity at a contacting portion is improved for heat dissipation from an electronic element in a controller section via the heat sink, the frame, and a bottom plate.

### CROSS REFERENCE TO RELATED APPLICATION

The present application is based on and claims the benefit of priority of Japanese Patent Application No. 2014-156478, filed on Jul. 31, 2014, the disclosure of which is incorporated herein by reference.

### TECHNICAL FIELD

The present disclosure generally relates to a drive device that has a motor section and a controller assembled by an interference fit along an axial direction.

### BACKGROUND INFORMATION

Conventionally, the drive device has a motor section and a controller, which controls a power supply for a winding of the motor section, and the controller is assembled along an axis direction, i.e., along a shaft direction, of the motor to complete the drive device. For example, the drive device disclosed in a patent document, Japanese Patent Laid-Open No. 2011-228379 (Patent document 1) has a motor section that accommodates a stator and a rotor and a heat sink combined along the axis direction to have one integrated body, in which a controller substrate with a power element, a capacitor, a rotational angle sensor and the like mounted thereon is attached on the heat sink with a screw.

The drive device in the patent document 1 has the heat sink fixedly attached to a motor case by inserting a claw on one end face of the motor case into plural protrusions on the heat sink and by bending the inserted claw. However, in such a fix method, a size of a contact surface between the heat sink and the motor case is not sufficiently reserved, thereby making a heat dissipation capacity to dissipate heat from the heat sink toward the motor case insufficient. Thus, the size of the heat sink is increased to be greater than required, thereby preventing the drive device to have a small volume and a light weight.

Further, the drive device of the patent document 1 is divided into two parts, i.e., into the first motor case having a cup shape, i.e., having a cylinder with bottom shape, and the second motor case that covers an opening of the first motor case for holding a bearing on each of both ends of the motor shaft, which makes a drive device to have a complicated structure.

In such a structure, if one of the bearing is held by the heat sink, the second motor case may be dispensed to have a simple structure for the drive device.

However, when the heat sink is fixed onto the motor case with the bending of the claw or with the screwing of the substrate, accuracy of such assembly will not be guaranteed, in terms of the coaxiality between the two bearings, i.e., between the heat sink and the motor case, which leads to a noise of the motor and/or a torque pulsation.

Further, the drive device used in the vehicle, especially the one used in the electric power steering device, is very tight installation restriction. Therefore, a fastening part should not protrude toward an outside of the heat sink or the motor case.

### SUMMARY

It is an object of the present disclosure to provide a drive device which is formed by assembling the motor section and the controller along the axis direction of the motor section to have an improved coaxiality of the assembled parts as well as an improved heat dissipation capacity.

In an aspect of the present disclosure, the drive device includes a motor section having a stator with a winding wire wound on the stator, a rotor disposed inside of the stator, and a shaft rotating together with the rotor. The drive device also includes a controller section disposed on one axial end of the motor section in which an electric element for controlling a power supply to the winding wire is disposed on a substrate. Further, the drive device includes a first bearing that provides support for a rotation of the shaft on an other axial end of the rotor that is opposite to the one axial end where the controller section is located. The first bearing has an inner ring attached to the shaft.

The drive device also includes a second bearing providing support for a rotation of the shaft on the axial end of the rotor, the second bearing located close to the controller section. The second bearing has an inner ring fixedly attached to the shaft. The driver device further includes a frame having a cylinder shape and covering a radial outside of the stator.

The drive device also includes a bottom plate (i) disposed on one axial end of the frame on a first bearing side and (ii) provides a first concave part that accepts an outer ring of the first bearing to accommodate the first bearing. The drive device further includes a heat sink (i) disposed at a position between the controller section and the motor section, (ii) providing, on a motor side where the motor section is located, a second concave part that accepts an outer ring of the second bearing to accommodate the second bearing and (iii) providing, on a side away from the motor side, support for the controller section and receiving heat from an electric element of the controller section.

One of a fitting outer wall of the heat sink, a fitting outer wall of the bottom plate, and a fitting inner wall of the frame are combined by an interference fit. Also, one of the first bearing and the second bearing serves as a first-assembled bearing on an opposite end of the shaft relative to the interference fitting between the outer wall and the inner wall. Further another one of the first bearing and second bearing serves as a later-assembled bearing on a same end of the shaft as the interference fitting between the outer wall and the inner wall.

Also, an axial position of the outer ring of the later-assembled bearing is regulated by a regulating member that is inserted at a position between (i) the later-assembled bearing and (ii) a bottom face of the first concave part or the second concave part corresponding to the later-assembled bearing.

The drive device of the present disclosure may have improved assembly accuracy, i.e., coaxiality, based on the inference fit between the fitting outer wall of one of the heat sink and the bottom plate and the fitting inner wall of the frame. Based on the assumption that the fitting outer wall of the second concave part are coaxially positioned in one body, i.e., as a single component, and that the fitting outer wall of the bottom plate and the first concave part is coaxially positioned in one body, i.e., also as a single component, the second bearing in the second concave part and the first bearing in the first concave part are coaxially positioned, or accurately aligned with each other, by the inference fit described above, thereby enabling the coaxial installation of the shaft by the two bearings on two axial, opposing ends in the motor section of the drive device and guaranteeing the perpendicular setting of the shaft against the bottom plate. Therefore, the tilt of the shaft leading to the motor noise or the pulsation of the motor is appropriately prevented.

The inference fit further contributes to the high heat conductivity between the heat sink and the frame and between the frame and the bottom plate, thereby improving the heat dissipation capacity of the drive device, i.e., from the electric element of the controller section to a bottom-plate bearing object which has the bottom plate attached thereto, via the heat sink, the frame and the bottom plate. Therefore, the product size and the product weight of the drive device are reduced by minimizing the size of the heat sink.

Further, in comparison to the structure using an outward-protruding flange for combining the heat sink and the frame with a screw, for example, the outer shape of the drive device becomes more slim and installable for a small space in the electric power steering device.

In addition, the size, e.g., a total length, of the contact face between the fitting components, which is limited only to a periphery portion, is minimized in the inference fitting structure, in comparison to the other combination structures, such as the claw bending or the like, thereby improving the water-tightness of the combination by the inference fit.

The inference fitting process may have a dimension error or an assembly error in the axial direction at a position between an end face of the later-assembled bearing and the bottom face of the concave part, which may be difficult to manage. However, the drive device of the present disclosure is equipped with a regulating member that regulates the axial position of the outer ring of the later-assembled bearing at a position between the later-assembled bearing and the bottom face of the concave part corresponding to the later-assembled bearing. In such manner, wobble of the later-assembled bearing is appropriately prevented.

### BRIEF DESCRIPTION OF THE DRAWINGS

Objects, features, and advantages of the present disclosure will become more apparent from the following detailed description made with reference to the accompanying drawings, in which:

FIG. 1 is a cross-sectional diagram of a drive device in a first embodiment of the present disclosure;

FIG. 2 is a cross-sectional diagram of the drive device along a II-II line in FIG. 1;

FIG. 3 is a configuration diagram of an electric power steering device to which the drive device in an embodiment of the present disclosure is applied;

FIG. 4 is a schematic diagram of a circuit of the drive device in an embodiment of the present disclosure;

FIG. 5 is a cross-sectional diagram of an assembly process of the drive device in the first embodiment of the present disclosure;

FIG. 6 is a cross-sectional diagram of the drive device in a second embodiment of the present disclosure;

FIG. 7 is a cross-sectional diagram of the drive device in a third embodiment of the present disclosure; and

FIG. 8 is a cross-sectional diagram of the assembly process of the drive device in the third embodiment of the present disclosure.

### DETAILED DESCRIPTION

The drive device according to the embodiments of the present disclosure is described based on the drawings. In the following embodiments, like numbers represent like parts, and the description of the same parts will not be repeated.

### First Embodiment

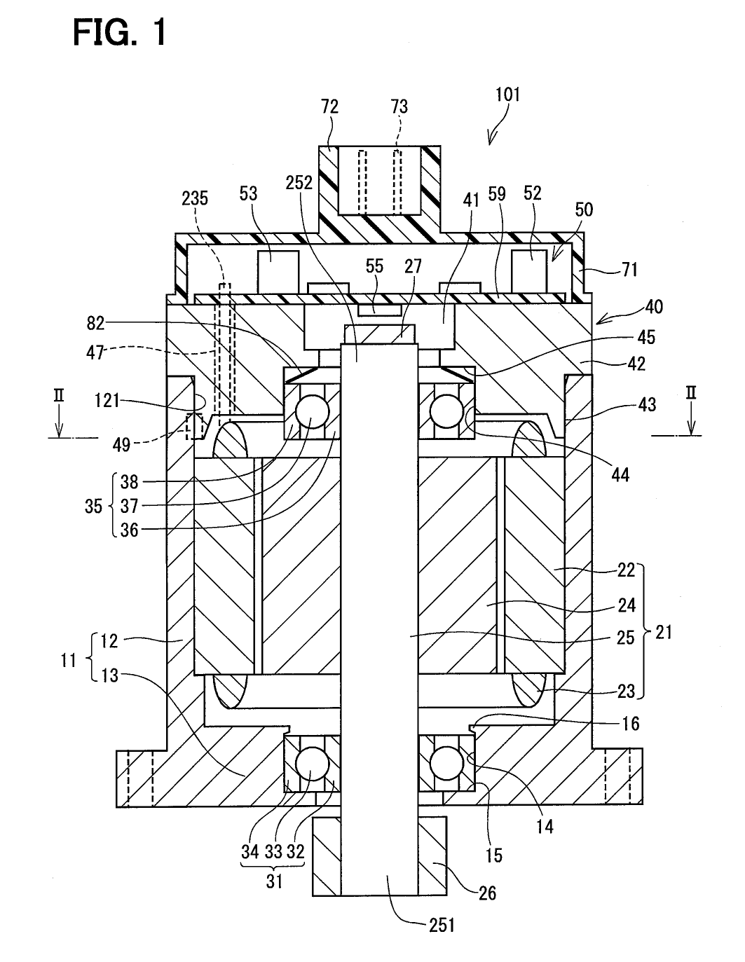

The drive device in the first embodiment of the present disclosure is described with reference to FIGS. 1-5.

A drive device 101 of the present embodiment is an actuator which is a one-body combination of a motor part and a controller part, among which the motor part generates a steering assist torque in an electric power steering device of a vehicle, and the controller part controls a power supply of the motor part.

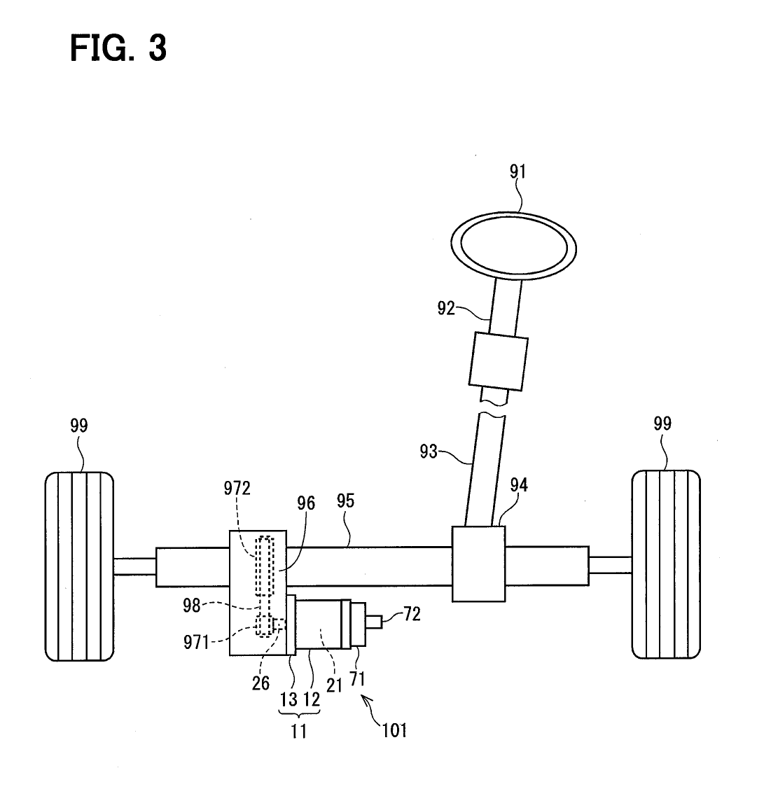

First, with reference to FIG. 3, the configuration of an electric power steering device 90 is described, to which the drive device 101 of the first embodiment and of the other embodiments is used.

The steering torque by a driver is transmitted from a steering wheel 91 to an intermediate shaft 93 via a steering shaft 92, and a rotational movement is turned into a straight-line, translational movement of a rack shaft 95 in a rack and pinion mechanism 94. Then, according to an amount of the straight-line movement of the rack shaft 95, a pair of wheels 99 is steered.

The electric power steering device 90 includes the drive device 101 and a power transmission device. The power transmission device is disposed in a box 96, and it transmits a rotation of a small pulley 971 to a large pulley 972, i.e., transmitting a torque from an output shaft 26 of the drive device 101 via a belt 98 from the pulley 971 to the pulley 972 while slowing down a rotation speed. The rotation of the large pulley 972 assists a translation movement of the rack shaft 95 with a conversion mechanism which is not illustrated.

The power transmission device may not only be provided by pulleys but may also be provided by gears or other means. Further, an installation position of the electric power steering device 90 may be other than an illustrated position, e.g., a position close to the rack and pinion mechanism 94. Further, the drive device 101 may be applied to a column-mount type electric power steering device in other embodiments.

The drive device 101 includes a motor case 11, a motor section 21 accommodated in the motor case 11, a cover 71, a connector 72 and the like. The motor case 11 of the present embodiment is formed as a one-body combination of a frame 12 in a cylindrical shape and a bottom plate 13, and the bottom plate 13 is attached to the box 96 of the power transmission device. The motor section 21 is constituted as a three-phase alternating current brushless motor of a permanent magnet synchronous type, for example, and a steering assist torque is generated by a rotation of the rotor according to a rotating magnetic field inside a stator 22.

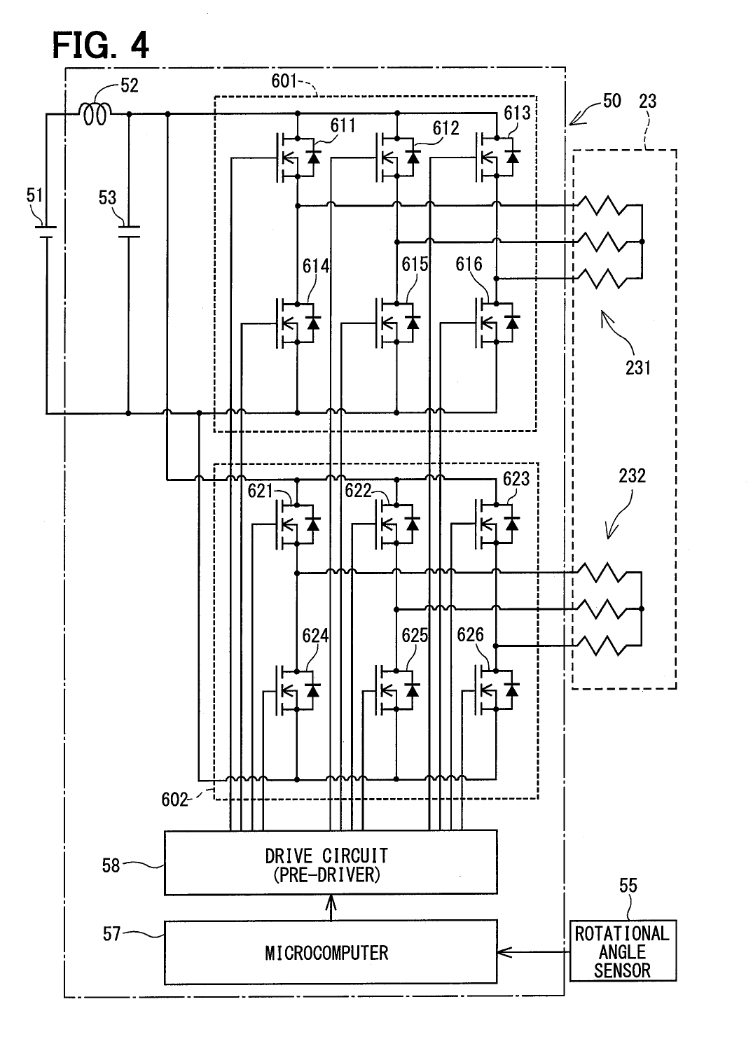

As shown in FIG. 4, a winding 23 of the motor section 21 of the present embodiment comprises two sets of three-phase winding groups 231 and 232, for example.

The inverter which converts the direct-current electric power of the battery 51 into a three-phase alternating-current electric power and outputs the electric power, comprises a first line inverter 601 formed corresponding to a first winding group 231 and a second line inverter 602 formed corresponding to a second winding group 232. Hereafter, the combination of an inverter and a three-phase winding group corresponding to the inverter is designated as a “system.”

A controller 50 is provided with a choke coil 52, a capacitor 53, a first system inverter 601, a second system inverter 602, a microcomputer 57, a drive circuit 58 and the like.

The choke coil 52 and the capacitor 53 constitute a filter circuit, and reduce a noise transmitted from the drive device 101 to other devices which share the battery 51 with the drive device 101, and also reduce a noise transmitted from the other devices sharing the battery 51 to the drive device 101. Further, the choke coil 52 controls and smooths pulsation of the voltage inputted into the inverters 601 and 602 from the battery 51.

The first system inverter 601 has six switching elements 611-616 having a bridge connection, and switches a power supply to the first winding group 231. The switching elements 611-616 of the present embodiment are Metal-Oxide Semiconductor Field Effect Transistor (MOSFET). Hereafter, switching elements 611-616 are hereafter designated as Metal-Oxide Semiconductor (MOS) 611-616.

As for MOS 611, 612, and 613 on a high potential side, the drain is connected to the positive terminal of the battery 51. The sauce of MOS 611, 612, and 613 is connected to the drain of MOS 614, 615, and 616 on a low potential side. The sauce of MOS 614, 615, and 616 is connected to the negative terminal of the battery 51. The junction point between MOS 611, 612, 613 on a high potential side and MOS 614, 615, 616 on a low potential side is respectively connected to one end of each phase winding of the winding group 231.

In the second system inverter 602, the configuration of switching elements (MOS) 621-626 is the same as that of the first system inverter 601.

The microcomputer 57 performs a calculation of a three-phase voltage instruction value based on a steering torque signal from a torque sensor which is not illustrated, a rotation angle signal from a rotational angle sensor 55, a feedback current, etc., for a control of the drive device.

The drive circuit 58 generates a Pulse Width Modulation (PWM) signal based on a three-phase voltage instruction value, and outputs the signal to the gate of MOS 611-616, 621-626 of the inverters 601 and 602. Based on the switching operation of MOS 611-616, 621-626 according to the PWM signal, a desired alternating voltage is applied to the winding groups 231 and 232 from the inverters 601 and 602, and the motor section 21 generates a steering assist torque.

The heat generated by the switching operation of MOS 611-616, 621-626 is received by a heat sink mentioned later, and failure of the MOS 611-616, 621-626 due to the excessive heat is prevented in advance.

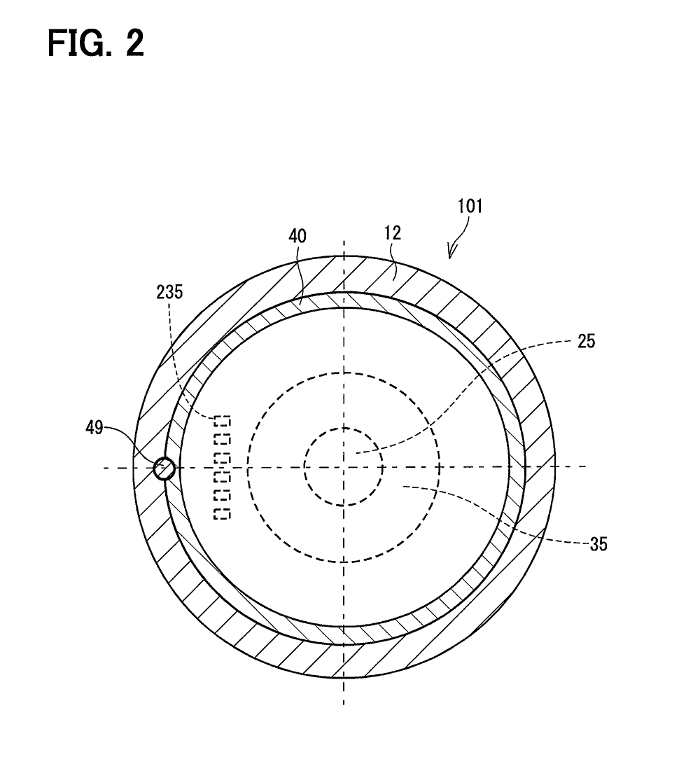

Next, the configuration of the drive device 101 of the first embodiment is described with reference to FIG. 1 and FIG. 2.

The drive device 101 is provided with the motor case 11, the motor section 21, a first bearing 31, a second bearing 35, a heat sink 40, the controller 50, the cover 71, the connector 72, and the like, as shown in FIG. 1.

The motor case 11 of the first embodiment is provided as a one integrated body of the cylinder-shaped frame 12 made with metal, e.g. aluminum, and the bottom plate 13 that is an output shaft 26 side of the frame 12. In contrast, in the third embodiment mentioned later, the frame and the bottom plate are two separate components, i.e., no component in the third embodiment corresponds to the motor case 11 of the first embodiment. That is, in the present disclosure, the frame and the bottom plate may be provided as a single part, or may be provided as two separate parts.

In the description of the first embodiment, for the compatibility with the description of the third embodiment, an expression “an inner wall of the frame 12” is prioritized than an expression “an inner wall of the motor case 11.”

The motor section 21 accommodated inside the frame 12 has the stator 22, the winding 23, a rotor 24, and a shaft 25, and is provided as a three-phase alternating current brushless motor in the present embodiment.

The stator 22 is formed substantially in a ring shape, for example, with a laminated steel plate etc., and is fixed in an inside of the frame 12.

The winding 23 is provided as a copper line, for example. The winding 23 is wound on the stator 22 to generate a rotating magnetic field when receiving an Alternating Current (AC). The winding 23 in the present embodiment is constituted as two sets of the three-phase winding groups 231 and 232 (refer to FIG. 4). An end part of the winding 23 in each of three-phase winding groups 231, 232 penetrates an insert hole 47 of the heat sink 40 to be electrically connected to a substrate 59 of the controller 50, which is designated as a winding extension part 235 hereafter.

In the present disclosure, details of the winding extension part 235 are omitted and the winding extension part 235 is simply drawn as a broken line in the drawing. In FIG. 2, six winding extension parts 235 are arranged in one row, which may also be a three by three arrangement in association with each of the two winding groups.

Just like the stator 22, the rotor 24 is formed substantially in a column shape, for example, with a laminated steel plate etc., and is rotatably disposed inside the stator 22. Plural permanent magnets which are not illustrated are disposed on an outer wall of the rotor 24, at preset intervals and with an N pole and an S pole alternating with each other along the circular direction.

The shaft 25 has a rod shape, for example, and is made with metal. The shaft 25 is coaxially disposed with the rotor 24, and the shaft 25 and the rotor 24 rotate together in one body. When the motor section 21 is accommodated in the motor case 11, one end of the shaft 25 located close to the bottom plate 13 is designated as a “first end 251”, and the other end of the shaft 25 located on the opening side of the frame 12 is designated as a “second end 252.”

The first end 251 of the shaft 25 penetrates the bottom plate 13, and the output shaft 26 for outputting torque is attached to the first end 251. In an example configuration of FIG. 3, the output shaft 26 is connected with the small pulley 971, and the torque generated by the motor section 21 is transmitted to the rack shaft 95 via the belt 98.

Further, the second end 252 of the shaft 25 has a magnet 27 attached thereto, which enables the rotational angle sensor 55 to detect a rotor rotation angle of the shaft 25.

An inner ring 32 of the first bearing 31 is fixed onto the first end 251 of the shaft 25 which is inserted into the rotor 24, and an inner ring 36 of the second bearing 35 is fixed onto the second end 252 thereof. The bearings 31 and 35 are radial bearings, for example, and rotatably support the shaft 25. The bearings 31 and 35 respectively comprise the inner rings 32 and 36, bearing balls 33 and 37, and outer rings 34 and 38, respectively.

A first concavity 14 that accommodates the first bearing 31 is disposed at a central part of the bottom plate 13 on a motor section 21 facing side, which is coaxial with a fitting inner wall 121 of the frame 12. The inner diameter of the first concavity 14 is set to enable a press-fitting of the outer ring 34 of the first bearing 31. Other detailed configuration about the assembly of the bearings 31 and 35 is mentioned later.

The heat sink 40 is made with thermally conductive metal, e.g. aluminum, and has a two-step disc shape which consists of a large-diameter base 42 and a small-diameter fitting outer wall 43. When the fitting outer wall 43 of the heat sink 40 fits into the fitting inner wall 121 of the frame 12, the opening of the frame 12 is closed.

Here, the outer dimension of the fitting outer wall 43 and the inner dimension of the fitting inner wall 121 of the frame 12 are configured to enable an inference fit of the two parts. Further, the fitting outer wall 43 is extended as long as possible to have a tight fitting with the fitting inner wall 121 while avoiding a contact with the winding 23. By extending the fitting outer wall 43, the fitting work of the outer wall 43 into the inner wall 121 is made easy in terms of linearly inserting the outer wall 43, as well as increasing the fitting area size between the outer wall 43 and the inner wall 121.

A positioner 49 is provided for a positioning of an assembly of the heat sink 40 to the frame 12, which regulates a rotational position of the heat sink 40 relative to the frame 12. In FIG. 2, the positioner 49 has a pin shape, which may also be a different shape, such as a square column shape or the like.

At a central part of the heat sink 40 on a side facing the motor section 21, a second concavity 44 that accommodates the second bearing 35 is provided, which is coaxial with the fitting outer wall 43. The inner diameter of the second concavity 44 is set enable a press-fitting of the outer ring 38 of the second bearing 35.

A sensor hole 41 in which the rotational angle sensor 55 is accommodated is bored at the central part of the heat sink 40 on a side facing the substrate 59. The bottom part of the sensor hole 41 communicates with the bottom part of the second concavity 44. The second end 252 of the shaft 25 extends into the sensor hole 41, which enables the magnet 27 attached to an end face of the second end 252 to be put close to the rotational angle sensor 55.

The controller 50 is disposed on a second bearing 35 side of the motor section 21, and is put on one side of the heat sink 40 facing away from the motor section 21. The controller 50 is constituted by electric elements on the substrate 59 which control a power supply to the winding 23.

As shown in FIG. 4, “the electric elements which control a power supply to the winding 23” includes, more practically, the choke coil 52, the capacitor 53, MOS 611-616, 621-626 that constitute the inverters 601 and 602, and Integrated Circuit (IC) which constitutes the microcomputer 57 and the drive circuit 58, together with other parts.

Further, in the present embodiment, the rotational angle sensor 55 is on a back side of the substrate 59. The rotational angle sensor 55, which may be a magneto-resistive element or a Hall device, for example, detects a change of the magnetic field of the magnet 27 attached at the tip of the shaft 25, for detecting the rotation angle of the rotor 24.

In the present disclosure, details of the arrangement of the electric elements and/or the mode of electrical connection are not described, since those matters are relevant to a feature of the present disclosure.

The substrate 59 is a printed circuit board which is made of an epoxy resin including a glass fiber, for example, and is fixed to have a contact with the heat sink 40. In such structure, heat of MOS 611-616, 621-626 from a switching operation thereof is dissipated directly or indirectly via the substrate 59 toward the heat sink 40, thereby preventing a failure of MOS 611-616, 621-626 due to a rise of the temperature.

The cover 71 and the connector 72 are formed to have one body with resin, for example.

The cover 71 has an outer edge section fixed to one side of the heat sink 40, which is facing away from the motor section 21, to cover the controller 50.

The cover 71 protects the controller 50 from an external shock, or prevents dust or water to intrude into the controller 50.

The connector 72 has a harness connected thereto which is not illustrated, for an input of a direct electric current from the battery 51 (see FIG. 4) and other signals such as Control Area Network (CAN) signals or a signal from a torque sensor, for example, to a connector terminal 73.

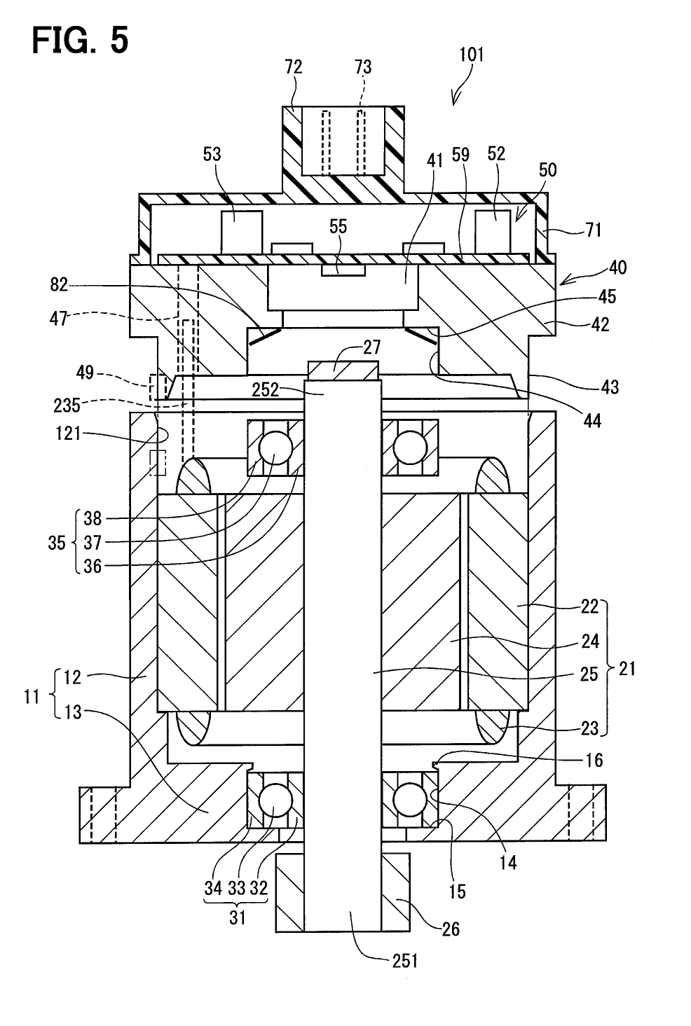

Then, with reference to FIG. 5, an assembly procedure of the drive device 101 of the first embodiment is described. According to the first embodiment, the heat sink 40 is attached to the frame 12 of the motor case 11 in which the motor section 21 is already accommodated prior to the attachment of the heat sink 40 to the frame 12. More practically, the drive device 101 is attached in the following manner.

Here, a focus of the assembly procedure is which one of the two bearings 31 and 35 is assembled first to the concavities 14 and 44. More specifically, which one of the outer ring 34 of the first bearing 31 and the outer ring 38 of the second bearing 35 is fitted to the concavities 14 and 44. Further, the bearing assembled before the inference fitting is designated as a “first-assembled bearing” which is a bearing on an opposite end in the axial direction to the inference fitting between the fitting outer wall 43 and the fitting inner wall 121, and the bearing assembled with the inference fitting is designated as a “later-assembled bearing” which is a bearing on an inference fitting end in the axial direction. In the first embodiment, the first bearing 31 is the first-assembled bearing, and the second bearing 35 is the later-assembled bearing.

A step-by-step description of the assembly follows.

(1) After press-fitting the outer ring 34 of the first bearing 31 to contact a bottom face 15 in the first concavity 14 of the bottom plate 13, a periphery of an opening of the first concavity 14 is caulked inward, to form a stopper 16.

(2) Fix the stator 22 of the motor section 21 in an inside of the frame 12. Then, the inner ring 32 of the first bearing 31 is press-fitted on the first end 251 of the shaft 25 that is being inserted into the rotor 24. The output shaft 26 is fixed onto the first end 251 of the shaft 25 projected to an outside of the bottom plate 13.

(3) Press-fit the inner ring 36 of the second bearing 35 on the second end 252 of the shaft 25.

(4) Set the second bearing 35 to face the second concavity 44 so that a biasing member 82 is put in a position in between the outer ring 38 of the second bearing 35 and a bottom face 45 of the second concavity 44. The biasing member 82 may be a heat-resistant resilient member, e.g. a wavy-shape washer, a leaf spring, or the like, which is assembled in position in an axially-compressed state for biasing the outer ring 38 away from the bottom face 45. The “biasing member” is one example of a “regulating member” which regulates the axial position of the outer ring along the shaft 25.

(5) Perform an inference fit, which may be one of (a) press-fitting, (b) shrink-fitting, or (c) cold-fitting, to fixedly press-fit the fitting outer wall 43 of the heat sink 40 into the fitting inner wall 121 of the frame 12.

In this inference fitting process, the outer ring 38 of the second bearing 35 is simultaneously press-fitted into the second concavity 44. In this case, “simultaneously” simply means substantially at the same time, which is not a strictly-same timing in the course of the inference fitting process.

The items (a), (b), and (c) mentioned above are now paraphrased.

(a) Press the heat sink 40 and the frame 12 at normal, room temperature, for the fitting.

(b) After inserting the heat sink 40 into the frame 12 that is heated to a high temperature, fix the heat sink 40 in the frame 12 with an inward shrinking reactive force exerted from the fitting inner wall 121 of the frame 12 to the fitting outer wall 43 when the temperature of the frame 12 drops, which causes the inner diameter of the fitting inner wall 121 to be equal to or smaller than the outer diameter of the fitting outer wall 43.

(c) After inserting the heat sink 40 into the frame 12, with the temperature of the heat sink 40 cooled to a low temperature, fix the heat sink 40 in the frame 12 with an outward expanding reactive force exerted from the fitting outer wall 43 of the heat sink 40 as the temperature of the fitting outer wall 43 rises back to the normal temperature, which causes the outer diameter of the fitting outer wall 43 to be equal to or greater than the inner diameter of the fitting inner wall 121.

The attachment of the controller 50 and the cover 71 onto the heat sink 40 may be performed before or after the fitting of the heat sink 40 into the frame 12. For example, when an influence of high temperature or coldness from the shrink fit or the cold fit is worried in terms of damaging the electric element, for example, the controller 50 may be attached to the heat sink 40 and the winding extension part 235 may be connected to the substrate 59 after the shrink fit or the cold fit.

The effects achieved by the drive device 101 of the present embodiment are described.

The drive device 101 combines the fitting outer wall 43 of the heat sink 40 and the fitting inner wall 121 of the frame 12 by an inference fitting, which achieves an improved coaxiality and accuracy for the drive device 101 in the assembled state, in comparison to the other combining method, such as the bending of the claw, screwing, use of the adhesive, or welding.

Further, based on positioning of the fitting outer wall 43 and the second concavity 44 in one body, or positioning of the fitting inner wall 121 and the first concavity 14 in one body, the coaxiality between the second bearing 35 in the second concavity 44 and the first bearing 31 in the first concavity 14 is guaranteed when the fitting outer wall 43 and the fitting inner wall 121 are coaxially combined by the fitting. That is, the shaft 25 is coaxially held by the bearings 31 and 35, i.e., perpendicularly to the bottom plate 13, thereby appropriately preventing the torque pulsation and the noise of the motor section 21 caused by the tilt of the shaft 25.

Further, when the heat sink 40 and the frame 12 are combined by the inference fit, it yields a good heat conductively therebetween via the contact portion. Therefore, heat of the electric elements in the controller 50 is dissipated to the box 96 (refer to FIG. 3) of the power transmission device from the heat sink 40 via the frame 12 and the bottom plate 13. Thus, the size of the heat sink 40 is reduced to the minimum, and the drive device 101 is configured to have a small volume and a light weight.

Further, in comparison to the structure using an outward-protruding flange for combining the heat sink 40 and the frame 12 with a screw, for example, the outer shape of the drive device 101 becomes more installable for a small space in the electric power steering device 90.

In addition, the size, e.g., a total length, of the contact face between the fitting components is minimized in the inference fitting structure, in comparison to the other combination structures, such as the claw bending or the like, thereby improving the water-tightness of the combination structure.

In the inference fitting process, the dimension of the gap between an end face of the second bearing 35 and the bottom face 45 of the second concavity 44 in the later-assembled bearing may vary, depending on the dimension accuracy of those parts and/or the assembly accuracy, which are difficult to manage. Therefore, by inserting a biasing member 81 which biases, i.e., presses, the end face of the outer ring 38 of the second bearing 35 at a position in between the second bearing 35 and the bottom face 45 of the second concavity 44, the outer ring 38 is pressed in the axial direction away from the bottom face 45, and the axial position of the outer ring 38 relative to the inner ring 36 is regulated by a bearing ball 37. Therefore, wobble of the second bearing 35 in the axial direction is appropriately prevented.

### Second Embodiment

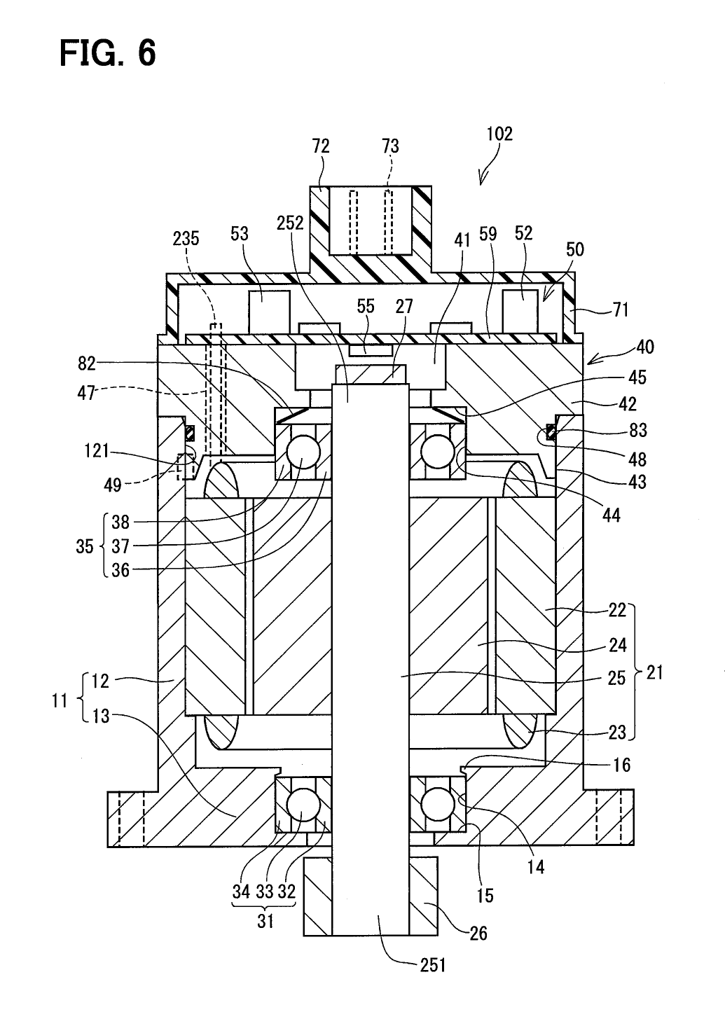

The drive device in the second embodiment of the present disclosure is shown in FIG. 6.

A drive device 102 in the second embodiment is different from the drive device 101 in the first embodiment in that a seal member 83 is inserted in a slot 48 that is formed on the fitting outer wall 43 of the heat sink 40. The seal member 83 is an O ring made of rubber, for example, and the seal member 83 seals a fluid (i.e., gas or liquid) at a position between the fitting outer wall 43 and the fitting inner wall 121 of the frame 12.

Since the rack-mount type electric power steering device 90 suffers from a rain water splashing from a road surface, a rain water dripping along the rack shaft 95, a leaking radiator fluid and washer fluid, which may intrude into the drive device 102, a water-proof character of the drive device 102 is on high demand. Therefore, the seal member 83 is effectively used in the drive device 102 in such a situation for providing water-proof character.

In addition, the drive device 102 of the second embodiment provides the same effects achieved by the first embodiment.

### Third Embodiment

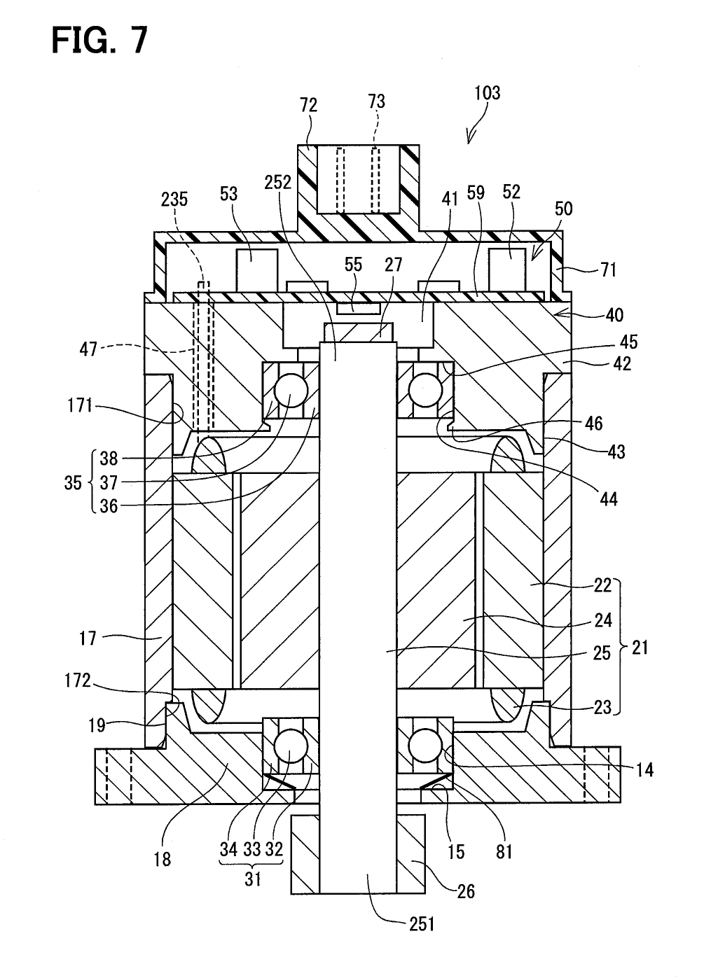

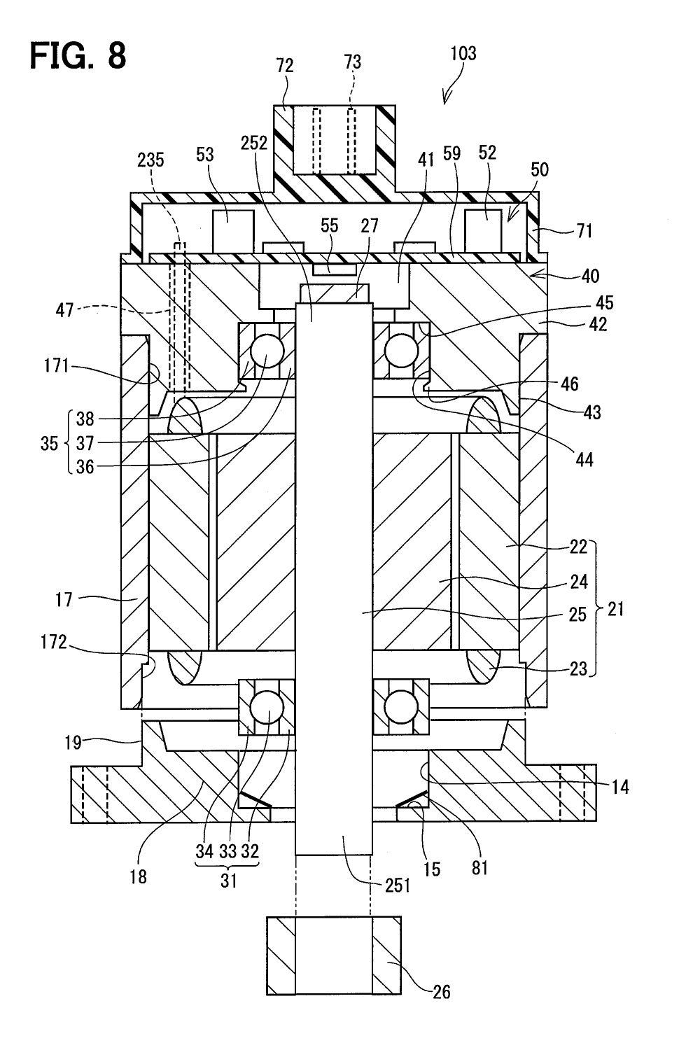

The drive device in the third embodiment of the present disclosure is described in the following with reference to FIG. 7 and FIG. 8.

According to the third embodiment, the configuration of the frame and the bottom plate, and an assembly order of the drive device differ from the first embodiment.

The drive device 103 of the third embodiment has a cylinder shape frame 17 and a bottom plate 18 provided in two separate pieces. The bottom plate 18 closes an opening of the frame 17 on an output shaft 26 side. The frame 17 has, on one end of the frame 17, a fitting inner wall 171 that is combinable with the fitting outer wall 43 of the heat sink 40 by fitting. On the other end of the frame 17, a fitting inner wall 172 that is combinable with a fitting outer wall 19 of the bottom plate 18 is provided.

Here, just like the first embodiment, the outer dimension of the fitting outer wall 19 is set to a suitable size against to the inner diameter dimension of the fitting inner wall 172 of the frame 17 for the inference fitting. Further, the fitting outer wall 19 is extended as long as possible to have a tight fitting with the fitting inner wall 172 while avoiding a contact with the winding 23. By extending the fitting outer wall 19, the fitting work of the outer wall 19 is made easy in terms of linearly inserting the outer wall 19 into the inner wall 172, as well as increasing the fitting area size between the outer wall 19 and the inner wall 172.

Then, with reference to FIG. 8, the assembly procedure of the drive device 103 of the third embodiment is described. According to the third embodiment, the bottom plate 18 is attached to the frame 17 after the installation of the motor section 21 into the frame 17. In detail, the drive device 103 is assembled in the following manner. According to the third embodiment, the second bearing 35 serves as a first-assembled bearing, and the first bearing 31 serves as a later-assembled bearing.

A step-by-step description of the assembly follows.

(1) After press-fitting the outer ring 28 of the second bearing 35 to contact the bottom face 45 in the second concavity 44 of the heat sink 40, a periphery of an opening of the second concavity 44 is caulked inward, to form a stopper 46.

(2) Perform an inference fit to combine the fitting outer wall 43 of the heat sink 40 and the fitting inner wall 171 of the frame 17, and fix the stator 22 of the motor section 21 in an inside of the frame 17. Then, press-fit the inner ring 36 of the second bearing 35 onto the second end 252 of the shaft 25 that is inserted into the rotor 24. The mounting of the magnet 27 onto the second end 252 may be performed before or after the above-described press-fitting.

(3) Press-fit the inner ring 32 of the first bearing 31 onto the first end 251 of the shaft 25.

(4) Set the first bearing 31 and the first concavity 14 in facing positions so that the biasing member 81 is put in between the outer ring 34 of the first bearing 31 and the bottom face 15 of the first concavity 14.

(5) Perform an inference fit, which may be one of (a) press-fitting, (b) shrink-fitting, or (c) cold-fitting, to fixedly press-fit the fitting outer wall 19 of the bottom plate 18 into the fitting inner wall 172 of the frame 17. In this inference fitting process, the outer ring 34 of the first bearing 34 is simultaneously press-fitted into the first concavity 14. The word “simultaneously” bears the same meaning as the first embodiment.

The details of the items (a), (b), (c) are the same as the first embodiment, with a replacement of the heat sink 40 in the first embodiment to the bottom plate in the present embodiment.

In the above-described manner, the coaxiality of the frame 17 and the bottom plate 18 is secured. Further, the thermal conductivity of a contact portion between the frame 17 and the bottom plate 18 is improved. Therefore, heat of the electric elements in the controller 50 is efficiently dissipated from the heat sink 40 to the bottom plate 18 via the frame 17.

Further, the outer ring 34 is biased, i.e., pressed, away in the axial position from the bottom face 15 by the biasing member 81 that is put in between the end face of the first bearing 31 and the bottom face 15 of the first concavity 14, and the axial position of the outer ring 34 relative to the inner ring 32 is regulated by the bearing ball 33. Therefore, wobble of the first bearing 31 in the axial direction is prevented.

Thus, in the third embodiment, the same effects as the above-mentioned embodiments are achieved. Further, the positioner 49 for regulating a rotational position between the heat sink 40 and the frame 17 or between the frame 17 and the bottom plate 18 may also be provided in the present embodiment, just like the above-mentioned embodiment. Further, a seam member for sealing a fluid may be provided at a position between the fitting outer wall 43 and the fitting inner wall 171 or between the fitting outer wall 19 and the fitting inner wall 171.

### Other Embodiments

(a) In the above-mentioned embodiments, the frame has a cylinder shape and the fitting outer wall of the heat sink or the bottom plate has a circular shape. However, a frame may have a cylinder shape in substance, i.e., may have a D character like tube shape, or may have a polygon cross section tube shape. When the cross section is non-rotationally symmetric, the positioner is dispensable.

(b) The drive device of the present disclosure described with the claim language “one of a fitting outer wall of the heat sink and a fitting outer wall of the bottom plate and a fitting inner wall of the frame are combined by an interference fit” indicates that, the fitting state of the inference fit may be not necessarily even for the entire circumference, depending on the dimension error of the fitting parts or based on a design requirement. Even in case that the fitting is partially performed as a transition-fit or as a loose-fit, the fitting is considered as an inference fit as a whole when the combination of the two parts is substantially established by press-fit, shrink-fit, or cold-fit.

(c) In addition, “one of a fitting outer wall of the heat sink and a fitting outer wall of the bottom plate and a fitting inner wall of the frame are combined by an interference fit” in the claim language does not necessarily mean that the combination of the two parts is established only by the inference fit. That is, the combination of the two parts may be established with other methods, such as a combined method of an inference fit and screw-fastening, caulking, adhesive bonding, welding or the like.

(d) According to the above-mentioned embodiments, “a biasing member 81 or 82 for pressing the end face of the outer ring 34 or 38 of the later-assembled bearing away from the bottom face 15 or 45” is used as “a regulating member for regulating an axial position of the outer ring of the later-assembled bearing.” In other embodiments, the regulating member may pull the outer ring of the later-assembled bearing closer to the bottom face.

(e) The configuration of the drive device in the present disclosure regarding a portion other than the feature portions, e.g., the inference fit portion, the bearing and the biasing member, may be arbitrarily determined other than the above-described manners. For example, the position and the shape of the winding extension part, the size, type, number, shape, material of the electric elements as well as providing a cover and a connector or not may be arbitrarily selected.

Further, in FIG. 4, the drive device is described as having two systems of inverters 61, 62 together with the two sets of winding groups 231, 232. However, the number of winding groups and corresponding inverters may be other than two, e.g., may be only one, or may be three or more.

(f) The assembly procedure of the drive device described in the above embodiments may be only an example. Processes other than the simultaneous inference fit (i.e., between a frame and one of a heat sink and a bottom plate) and press-fit (i.e., between an outer ring of a later-assembled bearing and a concave part) may be arbitrarily performed in the assembly procedure, such as using a sub-assembly part or the like.

(g) The motor constituted as the “motor section” in the claims of the present disclosure may be not only the three-phase alternating current synchronous motor of a permanent magnet type but also a poly-phase motor of four or more phases or a Direct Current (DC) brushless motor, an induction motor, etc. When the motor does not have to detect its rotation position, the magnet on the end face as well as the position detector of the present disclosure may be dispensed with.

(h) The drive device of the present disclosure may be applied to a rack-mount type electric power steering device or to a column-mount type electric power steering device. Further, the drive device may be applied to other devices other than the electric power steering device.

Although the present disclosure has been described in connection with preferred embodiment thereof with reference to the accompanying drawings, it is to be noted that various changes and modifications will become apparent to those skilled in the art, and such changes, modifications, and summarized schemes are to be understood as being within the scope of the present disclosure as defined by appended claims.

What is claimed is:

1. A drive device comprising:
a motor section having a stator with a winding wire wound on the stator, a rotor rotatably disposed inside of the stator, and a shaft rotating together with the rotor;
a controller section disposed on one axial end of the motor section in which an electric element for controlling a power supply to the winding wire is disposed on a substrate;
a first bearing providing support for a rotation of the shaft on an other axial end of the rotor that is opposite to the one axial end where the controller section is located, the first bearing having an inner ring fixedly attached to the shaft;
a second bearing providing support for a rotation of the shaft on the axial end of the rotor, the second bearing located close to the controller section, the second bearing having an inner ring fixedly attached to the shaft;
a frame having a cylinder shape and covering a radial outside of the stator;
a bottom plate (i) disposed on one axial end of the frame on a first bearing side and (ii) providing a first concave part that fixedly accepts an outer ring of the first bearing to accommodate the first bearing;
a heat sink (i) disposed at a position between the controller section and the motor section, (ii) providing, on a motor side where the motor section is located, a second concave part that fixedly accepts an outer ring of the second bearing to accommodate the second bearing and (iii) providing, on a side away from the motor side, support for the controller section and receiving heat from an electric element of the controller section, wherein
one of a fitting outer wall of the heat sink, a fitting outer wall of the bottom plate, and a fitting inner wall of the frame are combined by an interference fit,
one of the first bearing and the second bearing serves as a first-assembled bearing on an opposite end of the shaft relative to the interference fitting between the outer wall and the inner wall,
an other one of the first bearing and second bearing serves as a later-assembled bearing on a same end of the shaft as the interference fitting between the outer wall and the inner wall, and
an axial position of the outer ring of the later-assembled bearing is regulated by a regulating member that is inserted at a position between (i) the later-assembled bearing and (ii) a bottom face of the first concave part or the second concave part corresponding to the later-assembled bearing.

2. The drive device of claim 1, wherein
the regulating member comprises a biasing member biasing an end face of the outer ring of the later-assembled bearing away from the bottom face.

3. The drive device of claim 1, wherein
the frame and the bottom plate are combined to have one body,
the first bearing is assembled first as the first-assembled bearing and the second bearing is assembled next as the later-assembled bearing, and
the heat sink and the frame form an interference fit with each other by a fitting between a fitting outer wall of the heat sink and a fitting inner wall of the frame.

4. The drive device of claim 1, wherein
a positioner that positions a rotational assembly position is provided to regulate a rotation assembly between the heat sink and the frame, or a rotation assembly between the frame and the bottom plate.

5. The drive device of claim 1, wherein
a seal member is provided at a position between the fitting outer wall of the heat sink and the fitting inner wall of the frame for sealing a fluid.

6. The drive device of claim 1, wherein
the drive device serves as a motor that outputs an assist torque that assists a steering operation of an electric power steering device in a vehicle.

7. The drive device of claim 6, wherein
the drive device is attached to a rack shaft of the vehicle.
